(19) United States
(12) Patent Application Publication
(10) Pub. No.: US 2023/0214554 A1
(43) Pub. Date: Jul. 6, 2023

(54) METHODS AND SYSTEMS FOR RESERVOIR SIMULATION

(71) Applicant: Schlumberger Technology Corporation, Sugar Land, TX (US)

(72) Inventors: Zhuoyi Li, Houston, TX (US); Antonina Kozlova, Houston, TX (US); Shingo Watanabe, Houston, TX (US); Kyrre Bratvedt, Richmond, TX (US); Jostein Natvig, Asker (NO); Matei Tene, Oslo (NO)

(21) Appl. No.: 18/174,058

(22) Filed: Feb. 24, 2023

Related U.S. Application Data
(63) Continuation of application No. 16/948,279, filed on Sep. 11, 2020.
(60) Provisional application No. 62/912,726, filed on Oct. 9, 2019.

(51) Int. Cl. E21B 49/00; E21B 44/00

(52) U.S. Cl. CPC E21B 49/008; E21B 44/00; E21B 2200/20; E21B 2200/22

(57) ABSTRACT

Improved reservoir simulation methods and systems are provided that employ a new velocity model in conjunction with a sequential implicit (SI) formulation or Sequential Fully Implicit (SF) formulation for solving the discrete form of the system of nonlinear partial differential equations. In embodiments, the new velocity model employs a fluid transport equation part based on calculation of phase velocity for a number of fluid phases that involves capillary pressure and a modification coefficient. In embodiments, the modification coefficient can be based on a derivative of capillary pressure with respect to saturation. In another aspect, the new velocity model can employ an estimate of the phase velocity of the water phase v_{w_est} that is based on one or more derivatives of capillary pressure of the water phase as a function of water saturation.

### CROSS-REFERENCE TO RELATED APPLICATION(S)

This application is a continuation of pending U.S. patent application Ser. No. 16/948,279, filed on Sep. 11, 2020, entitled “Methods and Systems for Reservoir Simulation”, which claims priority from U.S. Provisional Application No. 62/912,726, filed on Oct. 9, 2019, entitled “Methods and Systems for Reservoir Simulation”. The contents of the disclosures are herein incorporated by reference in their entirety.

### FIELD

This disclosure relates to the hydrocarbon industry and petroleum reservoir engineering. In particular, this disclosure relates to methods and systems for simulating fluid flow in a reservoir.

### BACKGROUND

A reservoir simulator is a processor-based system that employs a discretized form of a set of partial differential equations to model multicomponent, multiphase fluid flow in natural porous media in the reservoir and possibly other fluid flow elsewhere in the production system. The governing system of equations used to describe the fluid flow is typically based on the assumption of thermodynamic equilibrium and the principles of conservation of mass, momentum and energy. The complexity of the physics that govern reservoir fluid flow leads to a system of coupled nonlinear partial differential equations that are not amenable to conventional analytical methods. As a result, numerical solution techniques are necessary. The numerical solution techniques divide the reservoir into computational elements (e.g., grid cells or grid blocks) that cover the spatial extent of the reservoir and divide time into time intervals or time steps (e.g., days or months). At each time step, the system of coupled nonlinear equations is solved. The most common method to solve these nonlinear systems of equations is the Newton-Raphson scheme, which is an iterative method where the approximate solution to the nonlinear system of equations is obtained by an iterative process of linearization, linear system solution and updating.

A variety of mathematical models, formulations, discretization methods, and solution strategies have been developed for use in reservoir simulators. The results of the reservoir simulator can be used to predict production rates from reservoirs and can be used to determine appropriate improvements, such as facility changes or drilling additional wells, that can be implemented to improve production.

Two well-known approaches for solving the discrete form of the system of nonlinear equations are the Sequential Implicit (SI) method and the Sequential Fully Implicit (SFI) method. Both of these methods decompose the system of equations into a first part (pressure or temperature equation) and a second part (fluid transport equation). The first and second parts are solved separately for their respective primary variables with the solution of the first part used as an initial guess in solving the second part. This process is repeated until convergence. Current implementations of these two methods can overshoot and lead to an unstable solution in cases which have high capillary pressure and multi-regions.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure describes an improved reservoir simulator that employs a new velocity model in conjunction with a sequential implicit (SI) formulation or Sequential Fully Implicit (SFI) formulation for solving the discrete form of the system of nonlinear partial differential equations. In embodiments, the new velocity model employs a fluid transport equation part based on calculation of phase velocity for a number of fluid phases that involves an estimated end of time step capillary pressure. The estimated end of time step capillary pressure can be based on a modification coefficient. In embodiments, the modification coefficient can be based on a derivative of capillary pressure with respect to saturation. The velocity model can be more stable than the traditional methodology which uses explicit saturation for the capillary pressure, and can improve the accuracy of the reservoir simulator, particularly for high capillary pressure or multi-regions.

In another aspect, the new velocity model can employ an estimate of the phase velocity of the water phase v_{w_est} that is based on one or more derivatives of capillary pressure of the water phase as a function of water saturation.

In embodiments, a reservoir simulator incorporating the new velocity model can be used to aid in determining drilling and/or completion strategies and associated parameters (e.g., production pressure, locations and settings of flow control valves, production pressure, etc.) that will help maximize/optimize the production of hydrocarbon fluids from the reservoir.

For example, the reservoir simulator can be used in determining locations that define a drilling path for drilling one or more wellbores in a formation containing a hydrocarbon reservoir and a completion for the wellbore(s). Thus, a proposed drilling path or drilling paths with defined segments, and components and parameters of the completion such as valves, pressures, etc., are specified in the reservoir simulator, and the simulator is run to perform a predictive simulation of the oilfield and provide expected production outputs over a specified timeframe. Changes are then made to the drilling path(s), and/or the completion automatically, or through operator intervention, and the reservoir simulator may be run again with the changed inputs. The outputs of the model simulate production from the reservoir over a specified time frame. The outputs may be evaluated to optimize the return on investment. When a desired solution is obtained, the formation is drilled accordingly.

In another example, once a formation has been drilled, the reservoir simulator can be used to optimize production of hydrocarbons in the formation. Thus, the geometry of the wellbore as well as components and parameters of the completion and optionally, the well rate, are specified in the reservoir simulator, and the simulator is run to perform a predictive simulation of production from the oilfield and provide expected production outputs over a specified timeframe. Changes are then made to the components and parameters of the completion, or well rates, automatically, or through operator intervention and the reservoir simulator may be run again with the changed inputs. When a desired solution is obtained, a completion is conducted with the components and parameters specified by the solution. At any time during production, additional information obtained from the formation may be entered into the reservoir simulator to update the reservoir simulator, and the model may be rerun to obtain results that may be used to modify the components and parameters of the completion.

### BRIEF DESCRIPTION OF DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 is a high-level schematic diagram of an example reservoir simulator and its operation;

FIG. 2 depicts plots of simulation results of field pressure from 0 to 100 days for one-time step using a fully-implicit-method (labeled FIM) and a sequential method (labeled SI/SFI). Both plots use the water velocity calculation that is based upon capillary pressure at the beginning of the time step. Note that the difference between the two methods after 100 days is over 800 psi;

FIG. 3 depicts plots of simulation results of field pressure from 0 to 100 days for one-time step using a fully-implicit-method (labeled FIM) and a sequential method (labeled SI/SFI). Both plots use the new improved water velocity calculation as described herein that is based upon estimated capillary pressure at the end of the time step. Note that the difference between the fully-implicit-method (labeled FIM) of FIG. 2 and the sequential method (labeled SI/SFI) of FIG. 3 at 100 days is less than 0.05 psi;

FIG. 4 depict plots of simulation results of water velocity calculations from 0 to 100 days for a simple two-cell model using the water velocity calculations (labeled “no_estimate and referred to as v_{w_regular} herein) that is based upon capillary pressure at the beginning of the time step and the new improved water velocity calculation (labeled “1/(1+a_pc*dt” and referred to as v_{w_est} herein) that is based upon estimated capillary pressure at the end of the time step. FIG. 4 also depicts a plot of simulation results of water velocity calculations from 0 to 100 days for a simple two-cell model using numerical simulation of the water velocity using small time step size (labeled “Numerical Simulation”); and

FIG. 5 is a block diagram of a computer processing system.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details in more detail than is necessary for the fundamental understanding of the subject disclosure, the description taken with the drawings making apparent to those skilled in the art how the several forms of the subject disclosure may be embodied in practice. Furthermore, like reference numbers and designations in the various drawings indicate like elements.

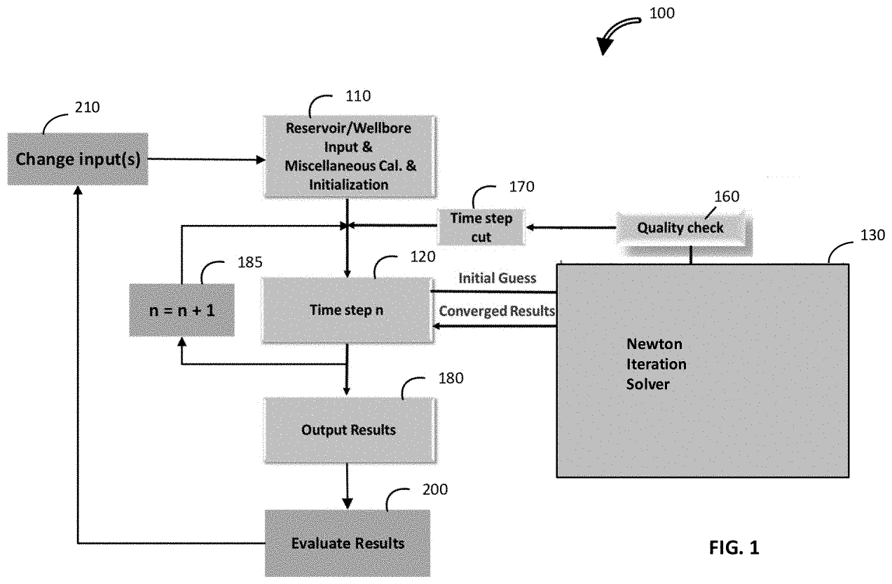

Turning to FIG. 1, a high-level schematic diagram is provided of a reservoir simulator 100. The reservoir simulator 100 is a processor-based system that employs a discrete form of a system of partial differential equations to model multi-phase, multiple component fluid flow in natural porous media through the reservoir. The reservoir simulator 100 can also model fluid flow from the reservoir to connected wellbore(s) and/or other associated production systems. The fluid in the reservoir typically includes three fluid phases: oil phase, gas phase, and water phase. Each fluid phase may contain different amounts of components, such as hydrocarbon components, carbon dioxide, hydrogen sulfide, nitrogen, and water. The governing equations typically used to describe the fluid flow in the reservoir are based on the assumption of thermodynamic equilibrium and the principles of conservation of mass, momentum and energy. The complexity of the physics that govern the fluid flow leads to systems of coupled nonlinear partial differential equations that are not amenable to conventional analytical methods. As a result, numerical solution techniques are necessary. The numerical solution techniques divides the reservoir into computational elements (e.g., cells or grid blocks) that cover the spatial extent of the reservoir and divide time into time intervals or time steps (e.g., days or months). At each time step, the coupled system of nonlinear equations is solved using Newton's method, which is an iterative method where the approximate solution to the nonlinear system is obtained by an iterative process of linearization, linear system solution and updating.

At 110, information regarding the reservoir and possibly one or more wellbores that traverse the reservoir (which can be drilled or a candidate for drilling), is input into the reservoir simulator 100. Such information can include location and properties of geological structures in the reservoir, initial distributions of reservoir fluid properties, such as volume fractions or mass fractions of constituent gaseous and liquid hydrocarbon components, carbon dioxide, hydrogen sulfide, nitrogen, and water, viscosity and fluid density of these components, and reservoir pressure and reservoir temperature. Also, by way of example, the information fed to the simulator may include information describing the number and location of connections between the reservoir and the wellbore(s), information describing location and operation of flow control devices (if installed), such as chokes and valves, labyrinth devices, and downhole separators, between the reservoir and the wellbore(s), information describing the geometry of the wellbore(s), and possibly other information such as information regarding enhanced-oil recovery methods or advanced production controls.

After parsing the information input in 110, the reservoir simulator 100 constructs one or more models that represent fluid flow in the reservoir and the connected wellbore(s). The model(s) include a system of discrete partial differential equations that models the fluid flow in the reservoir. The reservoir simulator 100 determines an approximate solution to the system of discrete partial differential equations for a time step n at 120 using Newton's method (Newton Iteration Solver 130). If the results of the Newton Iteration Solver 130 do not converge, a quality check 160 can be used to stop the process so that a reduced time step can be used at 170 and the process repeated for the reduced time step. However, where the results converge, the results for time step n are provided as output results at 180. The operations may then continue by stepping through time (n=n+1) at 185 and running the Newton Iteration Solver 130 for the next time step. Eventually, the results for all times of interest are assessed at 200 for suitability (e.g., return on investment). Changes can be made to the inputs at 210 and the operations of the reservoir simulator 100 repeated to evaluate different drilling strategies and/or production strategies as described herein.

The Newton Iteration Solver 130 can employ the Sequential Implicit (SI) method or the Sequential Fully Implicit (SFI) method to solve the system of discrete partial differential equations representing fluid flow in the reservoir. Both of these methods decompose the system of equations into a first part (pressure equation) and a second part (fluid transport equation). The first part (pressure equation) is solved first using the current saturation to evaluate relative permeability and capillary pressure. The resulting pressure and capillary pressure is used to calculate the phase velocity of each fluid phase (i.e., oil, gas, or water) and then a constant total velocity. The second part (fluid transport equation) is solved using the constant total velocity. This process can be repeated until convergence.

In embodiments, the reservoir simulator 100 may be a simulator such as the INTERSECT® simulator of Schlumberger.

In reservoir simulators, the phase velocity v for the water phase as part of the Sequential Implicit (SI) method or the Sequential Fully Implicit (SFI) method can be calculated using the Darcy's law as follows:

v=T·m·∇(P+Pc−μg∇z) Eqn. (1)

where T is the transmissibility
m is the upwind mobility of water phase,
∇ is the gradient function,
P is the pressure,
Pc is water capillary pressure,
ρ is the water density,
g is the gravitational constant, and
∇z is the vertical distance of two cells.

In such formulations of the Sequential Implicit (SI) method and the Sequential Fully Implicit (SFI) method, the first part (pressure equation) is solved first using the current saturation to determine relative permeability and capillary pressure Pc. Pressure and the capillary pressure Pc is used to calculate the water phase velocity and then a constant total velocity. The second part (fluid transport equation) is solved using the constant total velocity. It is widely used in academia and industry.

In embodiments, the reservoir simulator 100 employs a new velocity model as part of the Sequential Implicit (SI) method or Sequential Fully Implicit (SFI) method. In the new velocity model, an estimated end time step capillary pressure Pc_est can be used in the phase velocity calculation as follows:

v=T·m·∇(P+Pc_est−μg∇z) Eqn. (2)

Eqn. (2) can be written as any one of Eqns. (3a), (3b) and (3c) below:

$$v = \{ \begin{matrix}c \cdot T \cdot m \cdot ∇ ( P + Pc - ρ g ∇ z ) \\ \begin{matrix}T \cdot m \cdot ∇ ( P + c \cdot Pc - ρ g ∇ z ) & \end{matrix} \\ T \cdot m \cdot ∇ ( P + c \cdot ( Pc - ρ g ∇ z ) )\end{matrix} \begin{matrix}Eqn . ( 3 a ) \\ Eqn . ( 3 b ) \\ Eqn . ( 3 c )\end{matrix}$$

In this new formulation, Pc is the capillary pressure determined from the solution of the first part (pressure equation), which is similar to the SI and SFI methods. In embodiments, the modification coefficient c can introduce a weighting on the phase velocity calculation based on one more derivatives of capillary pressure as a function of saturation, such as

$$\frac{{dPc}_{s}}{ds} and \frac{{dPc}_{t}}{ds}$$

where

$$\frac{{dPc}_{s}}{ds}$$

is me capillary pressure derivative with respect to water saturation for the source cell and

$$\frac{{dPc}_{t}}{ds}$$

is the capillary pressure derivative with respect to water saturation for the target cell. In other embodiments, the modification coefficient c can introduce a weighting on phase velocity calculation based on the ratios

$$\frac{{dPc}_{s}}{ds} / {ϕ}_{s} and \frac{{dPc}_{t}}{ds} / {ϕ}_{t}$$

where ϕₛ is the pore volume of the source cell and ϕₜ is the pore volume of the target cell. For example, the modification coefficient c can be derived as:

$$c = \frac{1}{1 + T \cdot m \cdot ( \frac{{dPc}_{s}}{ds} / {ϕ}_{s} + \frac{{dPc}_{t}}{ds} / {ϕ}_{t} ) \cdot Δ t} \qquad Eqn . ( 4 )$$

where Δt is time step size.
   The modification coefficient c can be upwind dependent.

A criteria can be used to determine which equation of Eqns. (3a), (3b), and (3c) to use. Another criteria can be used to determine whether this new formulation is needed for a particular location (e.g., grid cell) in the reservoir.

The phase velocity calculation as described herein or its time-average integration can be applied to the first part (pressure equation) and used to compute the phase velocity, and further compute the total velocity.

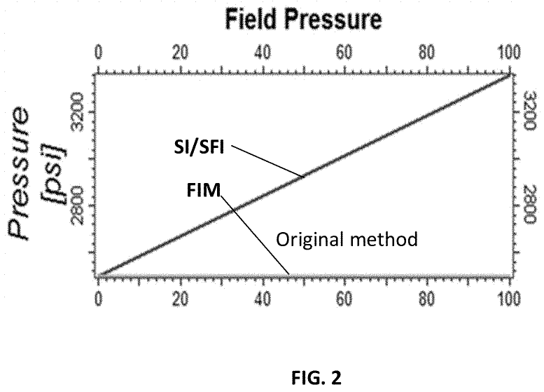

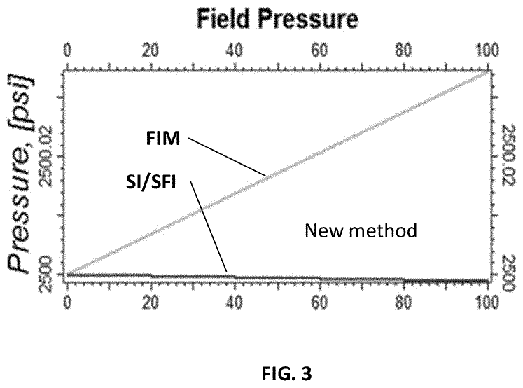

FIGS. 2 and 3 illustrate a two-cell synthetic case with certain input. One can observe that the pressure determined from the SI/SFI method with velocity method (i.e., Eqn. (1)) may increase about 900 psi compared to fully implicit method (FIM or FM), which is a reference solution. Using the new velocity model, the SI/SFI will have less than 0.05 psi difference compared to FIM.

For some other inputs, the SI/SFI methodology with the prior art velocity calculations may not be able to converge in the pressure problem. However, when using the new velocity model, the improved SI/SFI methodology can converge easily and the solution is very close to the referenced FIM solution.

The new velocity model has also been tested on a client model with high capillary pressure and multi-regions. It achieves 1-2 order material balance error improvement compared to the previous method (i.e., Eqn. (1)).

In another aspect, the new velocity model can employ an estimate of the phase velocity of the water phase v_{w_est} that is based on one or more derivatives of capillary pressure as a function of saturation, such as

$$\frac{{dPcw}_{so}}{dsw} and \frac{{dPcw}_{to}}{dsw} where \frac{{dPcw}_{so}}{dsw}$$

is the capillary pressure derivative with respect to water saturation for the source cell and

$$\frac{dPc {w}_{t 0}}{dsw}$$

is the capillary pressure derivative with respect to water saturation for the target cell. In other embodiments, v_{w_est} can be based on the ratios

$$\frac{dPc {w}_{s o}}{dsw} / {ϕ}_{s} and \frac{dPc {w}_{t 0}}{dsw} / {ϕ}_{t}$$

where ϕₛ is the pore volume of the source cell and ϕₜ is the pore volume of the source cell. For example, v_{w_est} can be derived as:

$${v}_{w \_ est} = \frac{{v}_{w \_ regular}}{1 + {a}_{p c} \cdot Δ t} \qquad Eqn . ( 5 a )$$

$${v}_{w - regular} = T \cdot {m}_{w} \cdot {pot}_{w} \qquad Eqn . ( 5 b )$$

$${a}_{p c} = T \cdot {m}_{w} \cdot ( \frac{dPc {w}_{s 0}}{dsw} / {ϕ}_{s} + \frac{dPc {w}_{t 0}}{dsw} / {ϕ}_{t} ) > 0. \qquad Eqn . ( 5 c )$$

where T is the transmissibility,
m_{w} is the upwind mobility of water phase,
pot_{w} is the potential difference of water phase between two cells, and
Δt is time step size.

The estimate of the phase velocity of the water component v_{w_est} replaces the original water velocity v_{w} to construct the pressure equation in the SFI method. It is for cases with high capillary pressure of the water phase (P_{cw}), and for certain location in the reservoir where there is high P_{cw} contrast between cells. If P_{cw} is very small, the derivative of the capillary pressure of the water phase relative to water saturation,

$$\frac{dPcw}{dsw}$$

will be very small, thus a_{pc} is close to 0. Then the difference between v_{w_est} and v_{w} will be ignored.

Eqns. (5a), 5(b) and 5(c) can be derived from a simple two-cell model of source and target that assume a connection between the two cells with sharp contact. If there is no other effect, the capillary pressure of the water phase, P_{cw}, will highly dominate the flux and disperse the saturation from the source cell to target cell. In this case,

$${v}_{w} = T \cdot {m}_{w} \cdot ( Po {t}_{{w}_{o t h e {r}_{0}}} + Δ P cw ) \qquad Eqn . ( 6 a )$$

$$Δ Pcw = P c {w}_{s} - P c {w}_{t} \qquad Eqn . ( 6 b )$$

where v_{w} is water phase velocity
T is transmissibility,
m_{w} is the upwind mobility of water phase,
Pot_{w} is water phase potential difference,
ΔPcw is the water capillary pressure,
Pcwₛ is water capillary pressure of source cell, and
Pcwₜ is water capillary pressure of target cell.

A simple estimate for the saturation of the source cell can be determined from:

$$s {w}_{s} = s {w}_{s 0} - {v}_{w} \cdot Δ t / {ϕ}_{s} \qquad Eqn . ( 7 a )$$

$$Pc {w}_{s} = P c {w}_{s 0} + \frac{dPc {w}_{s 0}}{dsw} \cdot Δsw\_s \qquad Eqn . ( 7 b )$$

where swₛ is water saturation of source cell,
swₛ₀ is water saturation of source cell at the beginning of pressure Newton,
v_{w} is water phase velocity,
Δt is time step size,
ϕₛ is pore volume of source cell,
Pcwₛ is source cell's water capillary pressure as a function of time,
Pcwₛ₀ is source cell's water capillary pressure at the beginning of pressure Newton,

$$\frac{dPc {w}_{s 0}}{dsw}$$

is source cell's water capillary pressure derivative with respect to water saturation, and
Δsw_s is change of water saturation of source cell.

Similarly, a simple estimate for the saturation of the target cell can be determined from:

$$s {w}_{t} = s {w}_{t 0} + {v}_{w} \cdot Δ t / {ϕ}_{t} \qquad Eqn . ( 8 a )$$

$$Pc {w}_{t} = P c {w}_{t 0} + \frac{dPc {w}_{t 0}}{dsw} \cdot Δsw\_t \qquad Eqn . ( 8 b )$$

where swₜ is water saturation of target cell,
swₜ₀ is water saturation of target cell at the beginning of pressure Newton,
v_{w} is water phase velocity,
Δt is time step size,
ϕₜ is pore volume of target cell,
Pcwₜ is target cell's water capillary pressure as a function of time,
Pcwₜ₀ is target cell's water capillary pressure at the beginning of pressure Newton,

$$\frac{dPc {w}_{t 0}}{dsw}$$

is target cell's water capillary pressure derivative with respect to water saturation, and
Δsw_t is change of water saturation of target cell.

Eqns. (7a), (7b), (8a) and (8b) can be combined to give:

$$Δ Pcw = P c {w}_{s} - P c {w}_{t} = P c {w}_{s 0} - P c {w}_{t 0} - ( \frac{dPc {w}_{s 0}}{dsw} / {ϕ}_{s} + \frac{dPc {w}_{t 0}}{dsw} / {ϕ}_{t} ) {v}_{w} \cdot Δ t \qquad Eqn . ( 9 )$$

Eqn. (6a) can be combined with Eqn. (9) to give:

$$Δ Pcw = {Pcw}_{s 0} - P c {w}_{t 0} - {a}_{p c} \cdot ( Po {t}_{{w}_{o t h e r} \_ 0} + Δ P cw ) \cdot Δ t \qquad Eqn . ( 10 a )$$

$${a}_{p c} = T \cdot {m}_{w} \cdot ( \frac{dPc {w}_{s 0}}{dsw} / {ϕ}_{s} + \frac{dPc {w}_{t 0}}{dsw} / {ϕ}_{t} ) > 0 \qquad Eqn . ( 10 b )$$

Eqns. (10a) and (10b) can be rewritten as:

$$Δ Pcw + P o {t}_{{w}_{o t h e r} \_ 0} = \frac{Δ Pc {w}_{0} + P o {t}_{{w}_{o t h e r} \_ 0}}{1 + {a}_{p c} \cdot Δ t} \qquad Eqn . ( 11 )$$

Eqn. (11) is the relationship of the estimated water phase potential difference at the end of time step and the water phase potential difference at the beginning of the time step. Using the Darcy's law based on water phase potential difference at the end of time step, one can have water velocity as Eqn. (12a)

$${v}_{w} = T \cdot {m}_{w} ( Δ Pcw + P o {t}_{{w}_{o t h e {r}_{0}}} ) \qquad Eqn . ( 12 a )$$

Compare the regular water phase velocity using Darcy's law based on water phase potential difference at the beginning of time step

$${v}_{w - regular} = T \cdot {m}_{w} \cdot po {t}_{w} = T \cdot {m}_{w} ( Δ Pc {w}_{0} + P o {t}_{{w}_{o t h e {r}_{0}}} ) \qquad Eqn . ( 12 b )$$

The relationship of v_{w} and v_{w_regular} is

$${v}_{w} = \frac{{v}_{w \_ regular}}{1 + {a}_{p c} \cdot Δ t} \qquad Eqn . ( 12 c )$$

where a_{pc} is the coefficient represented by Eqn. (10b), and
Δt is time step size.

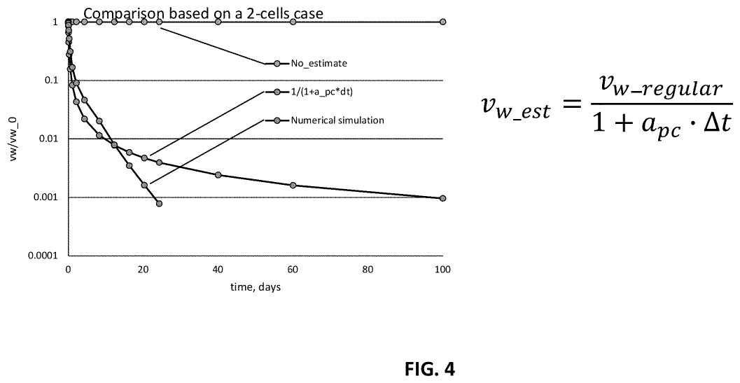

FIG. 4 shows the original water velocity, v_{w_regular} as well as the new estimated water velocity, v_{w_est} as a function of time/time step size (x axis) for a simple two-cells model. FIG. 4 also shows numerical simulation of the water velocity using small time step size for comparison purposes. Note that in the event that the current time step size is too big, the estimated v_{w_est} may prevent overshooting.

In embodiments, a reservoir simulator incorporating the new velocity model as described herein can be used to aid in determining drilling and/or completion strategies and associated parameters (e.g., production pressure, locations and settings of flow control valves, production pressure, etc.) that will help maximize/optimize the production of hydrocarbon fluids from the reservoir.

For example, the reservoir simulator can be used in determining locations that define a drilling path for drilling one or more wellbores in a formation containing a hydrocarbon reservoir and a completion for the wellbore(s). Thus, a proposed drilling path or drilling paths with defined segments, and components and parameters of the completion such as valves, pressures, etc., are specified in the reservoir simulator, and the simulator is run to perform a predictive simulation of the oilfield and provide expected production outputs over a specified timeframe. Changes are then made to the drilling path(s), and/or the completion automatically, or through operator intervention, and the reservoir simulator may be run again with the changed inputs. The outputs of the model simulate production from the reservoir over a specified timeframe. The outputs may be evaluated to optimize the return on investment. When a desired solution is obtained, the formation is drilled accordingly.

In another example, once a formation has been drilled, the reservoir simulator can be used to optimize production of hydrocarbons in the formation. Thus, the geometry of the wellbore as well as components and parameters of the completion and optionally, the well rate, are specified in the reservoir simulator, and the simulator is run to perform a predictive simulation of production from the oilfield and provide expected production outputs over a specified timeframe. Changes are then made to the components and parameters of the completion, or well rates, automatically, or through operator intervention and the reservoir simulator may be run again with the changed inputs. When a desired solution is obtained, a completion is conducted with the components and parameters specified by the solution. At any time during production, additional information obtained from the formation may be entered into the reservoir simulator to update the reservoir simulator, and the model may be rerun to obtain results that may be used to modify the components and parameters of the completion.

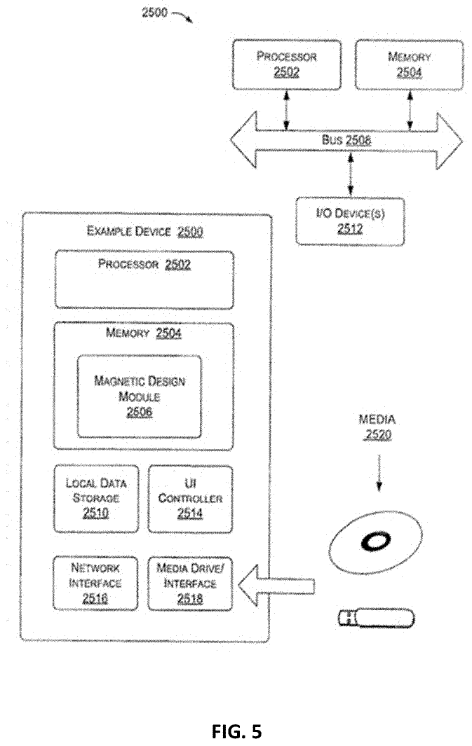

FIG. 5 illustrates an example device 2500, with a processor 2502 and memory 2504 that can be configured to implement various embodiments of the reservoir simulator as discussed in this disclosure. Memory 2504 can also host one or more databases and can include one or more forms of volatile data storage media such as random-access memory (RAM), and/or one or more forms of nonvolatile storage media (such as read-only memory (ROM), flash memory, and so forth).

Device 2500 is one example of a computing device or programmable device and is not intended to suggest any limitation as to scope of use or functionality of device 2500 and/or its possible architectures. For example, device 2500 can comprise one or more computing devices, programmable logic controllers (PLCs), etc.

Further, device 2500 should not be interpreted as having any dependency relating to one or a combination of components illustrated in device 2500. For example, device 2500 may include one or more of computers, such as a laptop computer, a desktop computer, a mainframe computer, etc., or any combination or accumulation thereof.

Device 2500 can also include a bus 2508 configured to allow various components and devices, such as processors 2502, memory 2504, and local data storage 2510, among other components, to communicate with each other.

Bus 2508 can include one or more of any of several types of bus structures, including a memory bus or memory controller, a peripheral bus, an accelerated graphics port, and a processor or local bus using any of a variety of bus architectures. Bus 2508 can also include wired and/or wireless buses.

Local data storage 2510 can include fixed media (e.g., RAM, ROM, a fixed hard drive, etc.) as well as removable media (e.g., a flash memory drive, a removable hard drive, optical disks, magnetic disks, and so forth).

One or more input/output (I/O) device(s) 2512 may also communicate via a user interface (UI) controller 2514, which may connect with I/O device(s) 2512 either directly or through bus 2508.

In one possible implementation, a network interface 2516 may communicate outside of device 2500 via a connected network.

A media drive/interface 2518 can accept removable tangible media 2520, such as flash drives, optical disks, removable hard drives, software products, etc. In one possible implementation, logic, computing instructions, and/or software programs comprising elements of module 2506 may reside on removable media 2520 readable by media drive/interface 2518.

In one possible embodiment, input/output device(s) 2512 can allow a user (such as a human annotator) to enter commands and information to device 2500, and also allow information to be presented to the user and/or other components or devices. Examples of input device(s) 2512 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various processes of present disclosure may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer. Some of the methods and processes described above, can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, or general-purpose computer) for executing any of the methods and processes described above.

Some of the methods and processes described above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A method comprising:
receiving data during production of fluid from a hydrocarbon reservoir, wherein the fluid comprises at least water and hydrocarbons;
updating a model of the hydrocarbon reservoir using the data, wherein the model characterizes the hydrocarbon reservoir in part by water saturation;
performing a multi-phase fluid flow simulation with respect to time using the model and a reservoir simulator to generate results, wherein the reservoir simulator implements a sequential solver that solves a pressure equation part for at least capillary pressure for computation of a water phase velocity and solves a transport equation part based at least in part on the water phase velocity for fluid transport in the reservoir, wherein the pressure equation part comprises an upwind in time coefficient that depends on at least one capillary pressure with respect to water saturation derivative to stabilize the reservoir simulator; and
optimizing production of hydrocarbons from the hydrocarbon reservoir based on the results.

2. The method of claim 1, wherein the results comprise hydrocarbon reservoir pressure values with respect to time.

3. The method of claim 1, wherein the results comprise hydrocarbon reservoir water phase velocity results.

4. The method of claim 1, wherein the result comprise hydrocarbon reservoir fluid flow results for a number of wells that extend into the hydrocarbon reservoir.

5. The method of claim 1, wherein receiving data comprises receiving data for one or more flow control devices and/or for an enhanced-oil recovery process.

6. The method of claim 1, wherein the upwind in time coefficient is equal to a reciprocal of one plus a product of transmissibility multiplied by mobility multiplied by a time step size multiplied by a sum of a first ratio and a second ratio, wherein the first ratio is of a capillary pressure with respect to water saturation derivative of a source cell divided by a source cell volume, and wherein the second ratio is of a capillary pressure with respect to water saturation derivative of a target cell divided by a target cell volume.

7. The method of claim 1, comprising performing a quality check during the multi-phase fluid flow simulation, detecting a stability issue, and, responsive to the stability issue, reducing a time step of the multi-phase fluid flow simulation to stabilize the reservoir simulator.

8. The method of claim 7, wherein, during the multi-phase fluid flow simulation, the reservoir simulator is stabilized by the upwind in time coefficient that depends on at least one capillary pressure with respect to water saturation derivative and by performing one or more instances of the quality check.

9. The method of claim 7, wherein reducing the time step causes a reduction in the upwind in time coefficient.

10. The method of claim 1, comprising determining a location in the model for implementation of the upwind in time coefficient that depends on at least one capillary pressure with respect to water saturation derivative to stabilize the reservoir simulator.

11. The method of claim 10, wherein the location depends on physical properties at a corresponding location in the hydrocarbon reservoir.

12. The method of claim 11, wherein the location in the hydrocarbon reservoir comprises a relative, high capillary pressure for pores in rock of the hydrocarbon reservoir.

13. The method of claim 1, wherein the reservoir simulator is stabilized with respect to water phase capillary pressure dominating fluid flux and dispersion of water saturation.

14. The method of claim 1, wherein, as water saturation derivative increases, the upwind in time coefficient decreases.

15. The method of claim 1, wherein, as a time step of the reservoir simulator decreases, the upwind in time coefficient decreases.

16. The method of claim 1, wherein optimizing production of hydrocarbons from the hydrocarbon reservoir based on the results comprises adjusting at least one flow control device.

17. A system comprising:
one or more processors;
a memory accessible to at least one of the one or more processors;
processor-executable instructions stored in the memory executable by the system to instruct the system to:
receive data during production of fluid from a hydrocarbon reservoir, wherein the fluid comprises at least water and hydrocarbons;
update a model of the hydrocarbon reservoir using the data, wherein the model characterizes the hydrocarbon reservoir in part by water saturation;
perform a multi-phase fluid flow simulation with respect to time using the model and a reservoir simulator to generate results, wherein the reservoir simulator implements a sequential solver that solves a pressure equation part for at least capillary pressure for computation of a water phase velocity and solves a transport equation part based at least in part on the water phase velocity for fluid transport in the reservoir, wherein the pressure equation part comprises an upwind in time coefficient that depends on at least one capillary pressure with respect to water saturation derivative to stabilize the reservoir simulator; and
optimize production of hydrocarbons from the hydrocarbon reservoir based on the results.

18. The system of claim 17, comprising the reservoir simulator.

19. The system of claim 17, comprising one or more interfaces that receive the data.

20. The system of claim 17, processor-executable instructions stored in the memory executable by the system to instruct the system to perform a quality check during the multi-phase fluid flow simulation, detect a stability issue, and, responsive to the stability issue, reduce a time step of the multi-phase fluid flow simulation to stabilize the reservoir simulator.

21. One or more non-transitory computer-readable media comprising process-executable instructions executable by a system to instruct the system to:
receive data during production of fluid from a hydrocarbon reservoir, wherein the fluid comprises at least water and hydrocarbons;
update a model of the hydrocarbon reservoir using the data, wherein the model characterizes the hydrocarbon reservoir in part by water saturation;
perform a multi-phase fluid flow simulation with respect to time using the model and a reservoir simulator to generate results, wherein the reservoir simulator implements a sequential solver that solves a pressure equation part for at least capillary pressure for computation of a water phase velocity and solves a transport equation part based at least in part on the water phase velocity for fluid transport in the reservoir, wherein the pressure equation part comprises an upwind in time coefficient that depends on at least one capillary pressure with respect to water saturation derivative to stabilize the reservoir simulator; and
optimize production of hydrocarbons from the hydrocarbon reservoir based on the results.
